(19) United States
(12) Patent Application Publication
(10) Pub. No.: US 2007/0073008 A1
(43) Pub. Date: Mar. 29, 2007

(54) Compositions effective to suppress void formation

(75) Inventors: James Hurley, Atlanta, GA (US); Senthil Kanagavel, Acworth, GA (US); Samir Avdic, Cumming, GA (US); Avin Dhoble, Alpharetta, GA (US); Tanya Berfield, Alpharetta, GA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Cookson Singapore PTE, LTD., Singapore (SG)

(21) Appl. No.: 11/237,610

(22) Filed: Sep. 28, 2005

(51) Int. Cl. C08L 63/02; C08L 61/12

(52) U.S. Cl. 525/523; 525/484

(57) ABSTRACT

A composition for use with a lead free solder is provided. In certain examples, the composition comprises an effective amount of a phenol to suppress void formation. Underfill compositions and devices that include the composition are also disclosed.

### FIELD OF THE TECHNOLOGY

Certain examples disclosed herein relate generally to compositions effective to suppress void formation. More particularly, certain examples relate to thermosetting epoxy compositions for use with a lead free solder and comprising an effective amount of a phenol to suppress void formation.

### BACKGROUND

There is a movement towards the use of environmentally friendly or “green” materials in the assembly and processing of electronic components. The use of “green” solders and fluxes, e.g., non-lead based solders and fluxes, however, may lead to incompatibility with other materials used in assembly and processing of electronic components.

### SUMMARY

Certain features, aspects and examples disclosed herein are directed to epoxy compositions that are effective to suppress void formation. In certain examples, a composition comprising an effective amount of a phenol to suppress void formation is provided. Embodiments of such compositions may provide significant advantages including, for example, compatibility with lead-free solders and fluxes, a reduced tendency to form voids and bubbles when used in, under or with electronic components, such as printed circuit boards, flip chip devices, etc., and the ability of at least certain compositions to retain their properties during and after reflow and/or rework processes.

In accordance with a first aspect, a composition comprising an effective amount of a phenol to suppress void formation is disclosed. In certain examples, the composition is compatible with a lead free solder such that it may be used in an underfill composition and/or in the processing of electronic components on a printed circuit board, e.g., in reflow and/or rework processes. In some examples, the effective amount of a phenol is about 2 equivalent percent to about 7 equivalent percent of a phenolic compound, wherein the remaining balance (93-98 equivalent percent) refers to other active curing agents, e.g., active hydrogen curing agents. In some examples, the composition may include 30 equivalent percent to about 90 equivalent percent of an aromatic amine, about 2 equivalent percent to about 20 equivalent percent of a phenol and about 8 equivalent percent to about 65 equivalent percent of a guanidine compound. In certain examples, aromatic amines and guanidine derivatives that include an active amino hydrogen group which may, under certain conditions, add across an oxirane (epoxy) group to create a condensation product as illustrated below may be used. 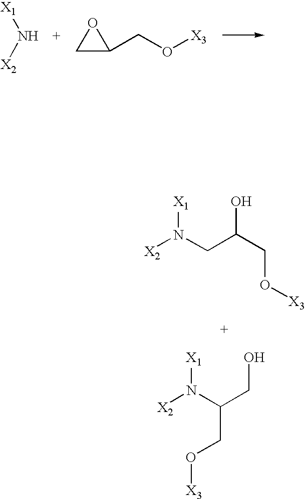
In the above illustration, X₁ may be an aliphatic or aromatic group, X₂ may be either hydrogen or an aliphatic group, and X₃ may be an aromatic group. In some examples, when the active hydrogen curing agents and the epoxy resin have at least about 2 (and preferably greater that 2) reactive groups per molecule, thermosetting materials may be obtained which possess desirable engineering properties. Additional materials, such as stress modifiers, coupling agents and the like may also be used with the compositions disclosed herein.

In accordance with another aspect, a composition for use with a lead free solder and in the processing of an electronic component is provided. In certain examples, the composition comprises an effective amount of a phenol to provide less than about 1% voids under the electronic component. In some examples, the composition comprises an effective amount of a phenol to provide less than about 0.1% voids under the electronic component. In other examples, the composition comprises an effective amount of a phenol to provide substantially no voids under the electronic component. The composition may also include one or more of an aromatic amine and a guanidine compound.

In accordance with an additional aspect, an underfill composition comprising a resin and a composition that includes an effective amount of a phenol to suppress void formation is disclosed. In certain examples, the underfill composition may include a 1:1 stoichiometry of resin:composition. In some examples, the resin may be an epoxy resin.

In accordance with another aspect, an underfill composition comprising a resin and a composition that includes an effective amount of a phenol to provide less than about 1% voids under the electronic component is provided. In certain examples, the underfill composition may include a 1:1 stoichiometry of resin:composition. In some examples, the resin may be an epoxy resin.

In accordance with an additional aspect, a device comprising a composition that includes an effective amount of a phenol to suppress void formation is disclosed. In certain examples, the device may be configured as a printed circuit board, a flip chip device or other electronic components commonly used in printed circuit boards.

In accordance with another aspect, a device comprising a composition that includes an effective amount of a phenol to provide less than about 1% voids under the electronic component is provided. In certain examples, the device may be configured as a printed circuit board, a flip chip device or other electronic components commonly used in printed circuit boards.

It will be recognized by the person of ordinary skill in the art, given the benefit of this disclosure, that the compositions provided herein, and devices using them, provide a substantial technological advance. Examples of the compositions disclosed herein may be used, for example, with green materials such as a lead-free solder, in assembly of printed circuit boards or components thereof, e.g., flip chips, and in rework and reflow processes. At least some of the compositions described herein provide improved properties over existing compositions including reduced (or no) bubble and void formation and the ability to pass JEDEC L3 humidity preconditioning. Additional features, examples and advantages of the compositions disclosed herein will be recognized by the person of ordinary skill in the art, given the benefit of this disclosure.

### BRIEF DESCRIPTION OF THE FIGURES

Certain aspects and examples are described below with reference to the accompanying figures in which:

FIG. 1 is an illustrative composition diagram with triangular coordinates for selecting amounts of an aromatic amine, a phenol and/or a guanidine compound suitable for use in the compositions disclosed herein, in accordance with certain examples;

FIGS. 2A-2B are scanning acoustic microscope images of a flip-chip device having different percentages of void area underneath the flip-chip device, in accordance with certain examples;

FIG. 3 is a schematic of a printed circuit board, in accordance with certain examples;

FIG. 4 is a scanning acoustic microscope image of a flip-chip device including the composition of Example 1, in accordance with certain examples; and

FIG. 5 is a graph of flow time versus temperature for the composition of Example 1, in accordance with certain examples.

It will be recognized by the person of ordinary skill in the art, given the benefit of this disclosure, that the examples shown in the figures are not necessarily drawn to scale. Certain features or components may have been enlarged, reduced, distorted or otherwise depicted in an unconventional manner to facilitate a better understanding of the illustrative features, aspects and examples disclosed herein. Unless otherwise clear from the context, the use of shading, dashes, hashes and the like is not intended to mean or to imply that any particular material, thickness, geometry or orientation is used.

### DETAILED DESCRIPTION

Examples of the compositions provided herein may be used, for example, in the assembly and processing of many different types of electronic components. For example, in embodiments where the compositions are used in an underfill and in the processing of electronic components added to printed circuit boards, the underfill may be injected or otherwise disposed between an electronic component and a printed circuit board (PCB) surface prior to processing of the electronic component/PCB assembly. During processing of the electronic component/PCB assembly, an effective amount of phenol present in the composition acts to suppress void formation between the electronic component and the PCB to provide a more reliable electronic component/PCB assembly. Though certain examples are described below with reference to processing of a flip chip or a device including a flip chip, such as, for example, a PCB with a flip chip, the compositions disclosed herein are not limited to use with flip chips or PCBs, but, instead, may be used in the assembly and/or processing of many different types of electronic components.

Also, certain specific examples are described herein with reference to chemical formulas. Unless otherwise clear from the context, the use of any chemical formulas herein, or in the figures, is not intended to imply that the particular chemical representation is drawn to scale or that the bond lengths, bond angles, orientations or stereochemistry (if shown) is limited to what is depicted.

As used herein, “equivalent percent” refers to 100 times the molar equivalents of a given hardener component, divided by the total number of hardener molar equivalents. To further illustrate the unit equivalent percent, the following illustrative example is provided. Assuming that a thermosetting epoxy composition includes three components, diethyltoluenediamine (DETDA), Tamanol™ 758 phenolic novolac and dicyandiamide, the epoxy equivalent weight of each component may be calculated. For example, for DETDA, the epoxy equivalent weight would be the molecular weight divided by the number of active hydrogen atoms (4) or about 178 g/mol divided by 4 equivalents/mole, which provides an epoxy equivalent weight of about 44.5 grams/equiv. Generally, the epoxy equivalent weight of each component is the molecular weight of the molecule divided by the number of reactive functionalities in the molecule (e.g., active hydrogen atoms). To calculate the equivalent percent of a given component i, it is necessary to first calculate the number of equivalents of i, then divide by the total number of equivalents present, and then multiply by 100. For example, a given composition may contain 9.128 phr (parts per hundred resin) DETDA, 10.663 phr Tamanol™ and 2.461 phr dicyandiamide. The respective number of equivalents is: 9.128 g/44.5 g/eq.=0.2051 eq. (DETDA), 10.663 g/104 g/eq=0.1026 eq. (Tamanol™), and 2.461 g/12 g/eq=0.2051 eq. (dicyandiamide). The total number of equivalents is equal to 0.251+0.1026+0.251=0.5128. The equivalent percentage of the individual components in the mixture is 100×0.2051/[0.2051+0.1026+0.2051]=40 equivalent percent (for each of DETDA and dicyandiamide), and 100×0.1026/[0.2051+0.1026+0.2051]=20.0 equivalent percent (for the Tamanol™). Assuming the epoxy has an epoxy equivalent weight of 195 g/equivalent, the number of epoxy equivalents in 100 grams=100 g/195 g/eq=0.5128 eq. If a composition is made which includes a 1:1 stoichiometry of resin:curative then, in certain examples, the moles of the resin will equal the moles of the curative. For example, if 100 g of liquid bisphenol A epoxy is used as a resin (equiv. weight of 195 g/equiv), then 0.513 moles of resin (100/195) would be present. To provide an equivalent amount of moles for the curative, the sum of the molar ratios of each component in the curative should add up to be 0.513 moles (i.e., (grams of DETDA/equiv weight of DETDA)+(grams of Tamanol/equiv. weight of Tamanol)+(grams of dicyandiamide/equiv weight of dicyandiamide)=0.513 moles). Variations are possible, where the epoxy and curative are not in stoichiometric balance. Typically, the ratio of epoxy equivalents to the curative equivalents will be in the range 0.5-1.5, e.g., about 0.7-1.3. It will be within the ability of the person of ordinary skill in the art, given the benefit of this disclosure to select suitable amounts of components to provide a desired molar ratio in the compositions disclosed herein.

In accordance with certain examples, a composition comprising an effective amount of a phenol to suppress void formation is disclosed. For example, the effective amount of a phenol reduces, deters or stops formation of voids under an electronic component during and/or subsequent to processing of the electronic component. The exact amount of phenol which provides an effective amount to suppress void formation may vary depending on the processing operation, the processing temperatures, pressures and the like. In certain examples, about 2-7 equivalent percent of a phenol may be present. In other examples, about 2-20 equivalent percent of phenol may be present. It will be within the ability of the person of ordinary skill in the art, given the benefit of this disclosure, to select effective amounts of a phenol to suppress void formation.

In accordance with certain examples, while the effective amount of a phenol acts to suppress void formation, some voids may still exist under an electronic component provided that reliability and/or performance of the electronic component remains satisfactory. Reliability tests may include air-to-air thermal cycling (e.g., JEDEC JESD22-A104B dated July, 2000) or liquid-to-liquid thermal shock (e.g., JEDEC JESD22-A106B dated June 2004). Without wishing to be bound by any particular scientific theory, it is believed that about 1% void area, based on the total area and as determined by scanning acoustic microscopy, is the maximum percentage of voids that may be present and still provide satisfactory performance of an electronic component. By reducing the amount of voids under an electronic component such as a flip chip, the performance and reliability of the electronic component may be improved. For example, an effective amount of a phenol may provide a composition that provides less than about 1% voids, based on total underfill area under the flip chip, more particularly less than about 0.5% voids, e.g., less than about 0.1%, or 0.05% voids.

In certain examples, the balance of the composition, e.g., 93-98 equivalent percent, may comprise one or more of at least one aromatic amine and at least one guanidine compound. The exact amount of each component may vary depending on the desired properties of the composition, the processing temperatures, pressures and the like. In certain examples, the effective amount of phenol may vary between about 0.5 equivalent percent and about 20 equivalent percent of a phenol, more particularly about 1 equivalent percent to about 16 equivalent percent of a phenol, e.g., about 2 equivalent percent to about 7 equivalent percent of a phenol. In certain examples, about 30 equivalent percent to about 90 equivalent percent of an aromatic amine may be used in the composition, more particularly about 50 equivalent percent to about 80 equivalent percent aromatic amine, e.g., about 60 equivalent percent to about 70 equivalent percent of an aromatic amine may be used in the composition. The composition may also include about 8 equivalent percent to about 65 equivalent percent of a guanidine compound, more particularly about 10 equivalent percent to about 35 equivalent percent of a guanidine compound, e.g., about 15 equivalent percent to about 30 equivalent percent of a guanidine compound may be used in the composition. Suitable ranges of each of the guanidine compound and aromatic amine typically depends on the competing concerns of a) moisture absorption of the resulting resins, and b) the shelf life and cure kinetics of the uncured composition. Generally, guanidine compounds such as dicyandiamide, have excellent long term storage stability but, under certain conditions, may display very fast cure kinetics at elevated temperatures. This desirable behavior is termed “latency.” On the other hand, guanidine-cured epoxy resins may absorb large amounts (3-5%) of moisture during storage in high-humidity environments, which can cause reliability issues. Aromatic amine-cured epoxies have comparatively lower moisture absorption (1-3%), which is beneficial for long-term reliability. However, their storage stability and elevated temperature cure rates may be inferior to dicyandiamide-cured epoxies. By blending dicyandiamide and aromatic amine hardeners with epoxies in the appropriate ratios, compositions may be obtained which possess good latency, without the disadvantages of excessive moisture absorption. In addition, it will be understood by the person of the ordinary skill in the art, given the benefit of this disclosure, that the various amounts of components in the composition are selected such that the percentages add up to no more than 100%.

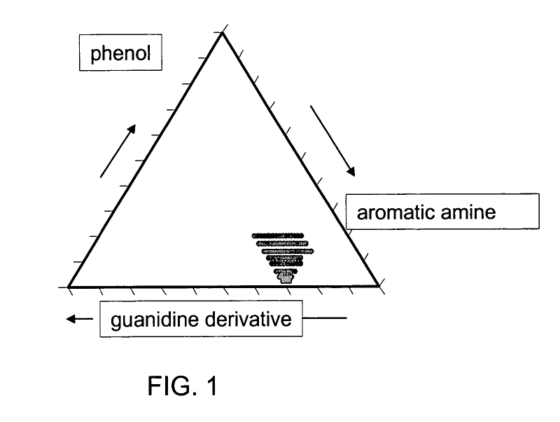

Referring now to FIG. 1, the amount of an aromatic amine, phenol and a guanidine compound in a combined hardener blend, e.g., for use with a lead free solder in the processing of an electronic component, may be selected using the triangular coordinates shown in FIG. 1. In certain examples, the equivalent percentage of the phenol may be between about 2 and about 7, the equivalent percentage of the aromatic amine component may be between about 50 and about 70, and the equivalent percent of the guanidine may be between about 15 and about 30, such that the sum of the phenol, aromatic amine and guanidine components equal 100 equivalent percent. Illustrative examples include: (1) phenol=2 equivalent percent, aromatic amine=68 to 70 equivalent percent, and guanidine derivative=(98 minus equivalent percent of aromatic amine); or (2) phenol=5 equivalent percent, aromatic amine=65 to 70 equivalent percent, and guanidine derivative=(95 minus equivalent percent of aromatic amine). An advantage to using the triangular coordinates shown in FIG. 1 is that it is only necessary to know or to select the amounts of two of the three components to select how much of each component should be used in the composition.

In certain examples, aromatic amines suitable for use in the compositions disclosed herein include, but are not limited to, a substituted aromatic amine, an unsubstituted aromatic amine, or a mixture thereof. In certain examples, the aromatic amine may be selected from at least one of an aromatic monoamine, an aromatic diamine or an aromatic triamine. In some examples, the aromatic amine may be a primary amine, a secondary amine or a tertiary amine. In certain examples, the aromatic amine may include a primary amine and may also include a secondary or tertiary amine. In examples where an aromatic amine is used, the aromatic amine may be a compound having formula (I) below:
R₁—NH₂ (I)
wherein R₁ may be a substituted phenyl group, an unsubstituted phenyl group, a substituted naphthyl group, an unsubstituted naphthyl group, a substituted toluenyl group, an unsubstituted toluenyl group or moieties that include these groups and other groups such as nitrogen, sulfur, phosphorous, etc., e.g., R₁ may be a phenyl, a naphthyl, or a toluenyl group which includes at least one amino moiety. In certain examples, R₁ may be selected such that an aromatic amine having formula (II) is used 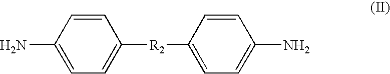
wherein R₂ may be methyl, ethyl, propyl, ethenyl, propenyl, butyl, butenyl, or other saturated or unsaturated hydrocarbons, e.g., a saturated aliphatic hydrocarbon having one to about six carbon atoms, a saturated cyclic hydrocarbon having three to about six carbon atoms, an unsaturated aliphatic hydrocarbon having two to about six carbon atoms, an unsaturated cyclic hydrocarbon having four to about six carbon atoms, or an aryl group.

In other examples, R₁ may be selected such that an aromatic amine having formula (III) is used 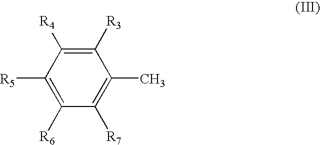
wherein at least one of R₃, R₄, R₅, R₆, and R₇ is the —NH₂ group shown in formula (I) and the other remaining groups may independently be selected from aryl, hydrogen, methyl, ethyl, propyl, ethenyl, propenyl, butenyl, or other saturated or unsaturated hydrocarbons, e.g., a saturated aliphatic hydrocarbon having one to about six carbon atoms, a saturated cyclic hydrocarbon having three to about six carbon atoms, an unsaturated aliphatic hydrocarbon having two to about six carbon atoms, or an unsaturated cyclic hydrocarbon having four to about six carbon atoms. In certain examples, R₃, R₄, R₅, R₆, and R₇ are selected to provide compounds having formulas (IV) and (V) shown below. 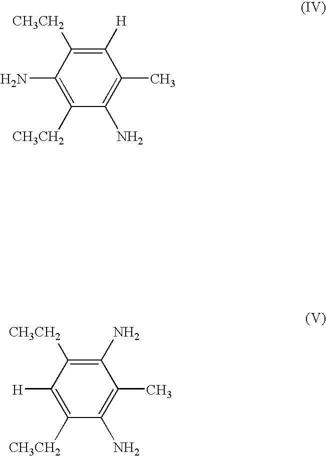
Suitable commercially available aromatic amines include, but are not limited to, an aromatic diethyltoluenediamine, 4,4′-methylenedianiline, Amicure 101, Ancamine 9360, Ancamine 9470, Ancamine Y, Ancamine Z (Air Products) and Curing Agent W (Hexion). Additional commercially available aromatic amines suitable for use in the compositions disclosed herein will be readily selected by the person of ordinary skill in the art, given the benefit of this disclosure.

In certain examples, a phenol suitable for use in the compositions disclosed herein includes a substituted phenol, an unsubstituted phenol or a mixture thereof. In certain examples, the phenol may be a solid or liquid phenol such as, for example, nonyl phenol, a phenolic novolac or an allyl-substituted phenolic novolac (e.g., Tamanol 758 from Arakawa Chemical, H-1, H-4, HF-1M, HF-4M, DL-92, MEH-8000-4L or MEH-8000H from Meiwa Chemical). In some examples, the phenol includes a compound having formula (VI) as shown below. 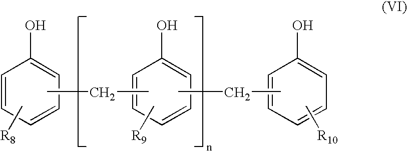
In formula (VI), n is typically between about 0 and about 8, more particularly, between about 1 and about 6, e.g., about 2 to about 4. Each of R₈, R₉ and R₁₀ may be covalently bonded to any free position, e.g., any free carbon, in its corresponding phenol ring. In certain examples, each of R₈, R₉ and R₁₀ may be independently selected from the group consisting of a hydrogen, a saturated aliphatic hydrocarbon including one to about six carbon atoms (e.g., methyl, ethyl, propyl), a cyclic saturated hydrocarbon including three to about six carbon atoms (e.g., cyclopropane, cyclobutane, cyclopentane, cyclohexane), an unsaturated aliphatic hydrocarbon including two to about six carbon atoms (e.g., ethylene, propylene, butylene), an unsaturated cyclic hydrocarbon including four to about six carbon atoms (e.g., cyclobutene, cyclopentene, cyclohexene) and aryl. In certain examples, each of R₈, R₉ and R₁₀ is selected to provide a compound having formula (VII) or formula (VIII), wherein n is about 0 to about 3 in formula (VII) and about 0 to about 4 in formula (VIII). 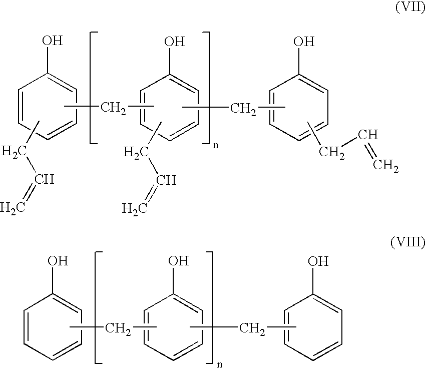
Suitable commercially available phenols include, but are not limited to, Tamanols™ such as Tamanol 758 (available from Arakawa Chemical in Chicago, Ill.), H-1, H-4, HF-1M, HF-4M, DL-92, MEH-8000-4L or MEH-8000-4L (available from Meiwa Chemical in Tokyo, Japan). In other examples, the phenol may be present in a resin, such as a xylok resin (Formula VIII(a)), a β-naphthol resin (Formula VIII(b)), a multifunctional resin (Formula VIII(c)), etc. 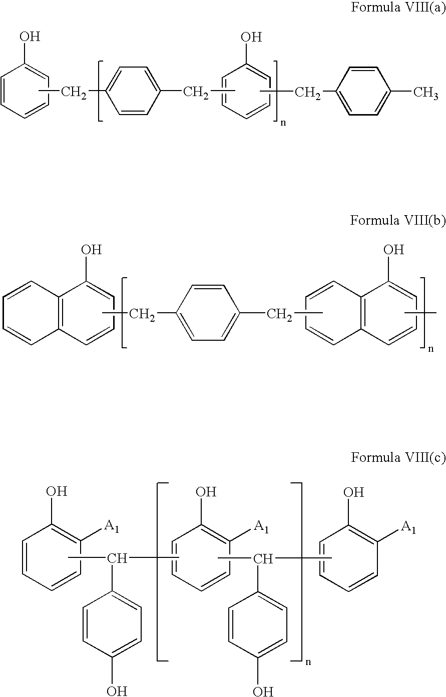
In formulae VIII(a), VIII(b) and VIII(c), n may be between 0 and 5, more particularly 1 to 4, e.g., 2 or 3. In formula VIII(c), A₁ may be hydrogen or a methyl group. The person of ordinary skill in the art, given the benefit of this disclosure, will be able to select additional commercially available phenols suitable for use in the compositions disclosed herein.

In certain examples, a guanidine compound suitable for use in the compositions disclosed herein includes those compounds having the —N—(C═N)—N— group of guanidine. Illustrative guanidine compounds may include guanidine itself or compounds having the guanidine backbone and at least one of a methyl group, an ethyl group, a cyano group, a phenyl group, a toluenyl group, an amide group, or a group containing one or more of a primary, secondary or tertiary amine. In certain examples, the guanidine compound is a compound having formula (IX) below. 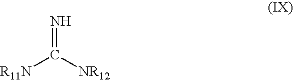
wherein each of R₁₁ and R₁₂ may be independently selected from a hydrogen, a methyl, a cyano group, an aryl group, a toluenyl group, an amino containing moiety, a saturated hydrocarbon including one to about six carbon atoms, a cyclic saturated hydrocarbon including three to about six carbon atoms, an unsaturated hydrocarbon including two to about six carbon atoms, and an unsaturated cyclic hydrocarbon including four to about six carbon atoms. In some examples R₁₁ and R₁₂ may be selected to provide a compound having formulas (X) or formula (XI) below. 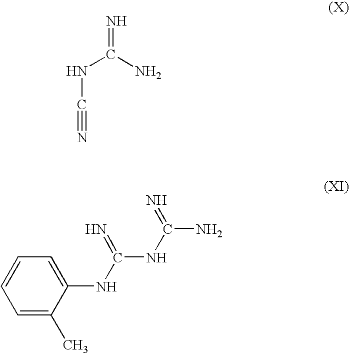
Suitable commercially available guanidine compounds include but are not limited to dicyandiamide (available from Alfa Aesar (Ward Hill, Mass.)), Aradur® compounds, e.g., Aradur® 2844 available from Huntsman Chemical (Salt Lake City, Utah), and the like. Additional commercially available guanidine compounds will be readily selected by the person of ordinary skill in the art, given the benefit of this disclosure.

In accordance with certain examples, the compositions disclosed herein may include one or more catalysts and/or accelerators, such as cure accelerators. The catalysts and/or cure accelerators may speed up curing of an underfill when used, for example, with a flip-chip device. Illustrative catalysts and/or cure accelerators include but are not limited to imidazoles such as Curezol® 2E4MZ, Curezol® C17Z, Curezol® 2PZ, etc., tertiary amines such BDMA (benzodimethylamine) and 1.8-Diazabicyclo (5.4.0)-7-undecene, N-methyl piperazine, triaryl phosphines, phosphonium salts, and substituted ureas, such as 1,1-Dimethyl-3-phenylurea and 1,1′-(4-methyl-m-phenylene)bis[3,3-dimethyl-; 1,1′-(4-Methyl-m-phenylene)bis(3,3′-dimethylurea). Additional catalysts and/or cure accelerators will be readily selected by the person of ordinary skill in the art, given the benefit of this disclosure. The catalysts and/or cure accelerators may be used alone or may be used in combination with one or more other catalysts and/or cure accelerators.

In accordance with certain examples, the compositions disclosed herein may include one or more additives. Illustrative additives include, but are not limited to, a coupling agent (e.g., a silane type coupling agent such as an epoxy-group-containing silane, an amino-group-containing silane, a mercapto-group-containing silane and a ureido-group-containing silane, a titanium type coupling agent such as organic titanate, an aluminum chelate such as an aluminum alcoholate, and an aluminum/zirconium type coupling agent), a flame retardant (e.g., a brominated epoxy resin, an antimony oxide (such as antimony trioxide, antimony tetraoxide and antimony pentaoxide), red phosphorus, a phosphate, a phosphonate, a compound having a triazine ring (such as melamine and a melamine derivative), a phosphorus-nitrogen type compound (such as cyclophosphazene), and a metal compound (such as a metal hydroxide, a zinc oxide, an iron oxide, a molybdenum oxide and ferrocene)), an ion trapping agent (e.g., a hydrotalcite, and a hydrous oxide, such as a hydrous oxide of bismuth, antimony, zirconium, titanium, tin, magnesium or aluminum), a diluent, a colorant, a dye, a pigment, a leveling agent, an anti-foaming agent and/or a solvent. Other suitable additives will be readily selected by the person of ordinary skill in the art, given the benefit of this disclosure. The exact amount of additive used may vary depending on the desired properties, and in certain examples, about 0.1 weight-percent to about 5.0 weight-percent of an additive may be used, more particularly, about 0.2 weight-percent to about 4.0 weight-percent of an additive may be used, e.g., about 0.3 weight-percent to about 3 weight-percent of an additive may be used.

In accordance with certain examples, the compositions disclosed herein may include one or more fillers. Such fillers include, but are not limited to an elastomer (e.g., rubber, natural rubber, SBS rubber, etc.), a glass fiber, carbon black, a silica such as fused silica and crystalline silica, calcium carbonate, clay, alumina such as fused alumina, silicon nitride, silicon carbide, boron nitride, calcium silicate, potassium titanate, aluminum nitride, beryllia, zirconia, zircon, foraterite, steatite, spinel, mullite and titania. Such fillers may take various forms, e.g., a powder, a bead, a gel, a sol or the like. In some examples, the particle size of such fillers may vary. For spherical particles, the particle size diameter may vary from about 1-50 microns, e.g., about 2-40 microns or about 3-30 or 5-20 microns. Additional fillers suitable for use in the compositions disclosed herein will be readily selected by the person of ordinary skill in the art, given the benefit of this disclosure. The exact amount of filler used may vary depending on the desired properties, and in certain examples, about 5 weight-percent to about 80 weight-percent of a filler may be used, more particularly, about 10 weight-percent to about 70 weight-percent of a filler may be used, e.g., about 20 weight-percent to about 60 weight-percent of a filler may be used.

In accordance with certain examples, the compositions disclosed herein may include at least one stress modifier. Any suitable stress modifier that provides a desired property, e.g., more or less tensile strength, may be used. Illustrative stress modifiers include, but are not limited to Paraloid® acrylic core-shell rubbers from Rohm & Haas, Hycar® carboxy terminated butadiene-nitrile rubbers from Noveon, and Ricon® functionalized liquid butadiene copolymers from Sartomer. The exact amount of stress modifier may vary depending on the desired properties, and in certain examples, about 0.5 weight-percent to about 10 weight-percent of a stress modifier may be used, more particularly, about 1 weight-percent to about 7 weight-percent of a stress modifier may be used, e.g., about 2 weight-percent to about 6 weight-percent of a stress modifier may be used. It will be within the ability of the person of ordinary skill in the art, given the benefit of this disclosure, to select suitable stress modifiers and suitable amounts of stress modifiers for use in the compositions disclosed herein.

In accordance with certain examples, the compositions disclosed herein may include at least one wetting agent. Illustrative wetting agents include, but are not limited to, BYK®-W 9010 and BYK®-W 909 (BYK-Chemie), Modaflow® (Solutia) and Silwet® 7608 (GE Silicones). The exact amount of wetting agent may vary depending on the desired properties, and in certain examples, about 0.1 weight-percent to about 3.0 weight-percent of a wetting agent may be used, more particularly, about 0.2 weight-percent to about 2.0 weight-percent of a wetting agent may be used, e.g., about 0.3 weight-percent to about 1.0 weight-percent of a wetting agent may be used. It will be within the ability of the person of ordinary skill in the art, given the benefit of this disclosure, to select suitable wetting agents and suitable amounts of a wetting agent for use in the compositions disclosed herein

In accordance with certain examples, the compositions disclosed herein may be used with a resin, e.g., an epoxy resin, to provide an underfill composition. The exact nature of the resin typically depends on the desired properties of the composition. In certain examples, a thermoset resin or a thermoplastic resin may be used. In other examples, a resin including at least one epoxy group may be used. The epoxy resin is preferably a liquid at ambient temperature. For example, the epoxy resin may be selected from liquid epoxy resins commonly used in epoxy resin compositions for encapsulating semiconductor devices, fiber optic splices and the like. Illustrative epoxy resins suitable for use with the compositions disclosed herein include, but are not limited to, epoxy resins obtained from bisphenol A, bisphenol F, bisphenol AD, bisphenol D, hydrogenated bisphenol A or the like. Other suitable resins include, but are not limited to, glycidyl ester type epoxy resins obtained by the reaction of polybasic acids such as phthalic acid and dimer acid with epichlorohydrin. Additional suitable epoxy resins include, but are not limited to, glycidylamine type epoxy resins obtained by the reaction of polyamines such as diaminodiphenylmethane and isocyanuric acid with epichlorohydrin. Other suitable resins include, but are not limited to, linear aliphatic epoxy resins and alicyclic epoxy resins, obtained by the oxidation of olefinic bonds with peracids such as peracetic acid. Depending on the desired characteristics of the underfill solution and/or the cured underfill, the epoxy resin component may comprise a single epoxy resin or a combination of epoxy resins. In one embodiment the epoxy resin component, or components where a blend is used, is selected from among glycidylethers of bisphenol A, glycidylethers of bisphenol F, naphthalenic epoxy, epoxy-functional reactive diluents, and others. For example, the resin may be selected from the group consisting of a diglycidyl ether of bisphenol A, a diglycidyl ether of bisphenol F, a triglycidyl ether of triphenomethane, a polyglycidyl ether of novolac, a polyglycidyl ether cresol novolac, a polyglycidyl ether of napthalenic phenol, and methyl, ethyl, propyl, and butyl substituted versions thereof. For example, it may be desirable to include a trifunctional epoxy resin to increase the amount of crosslinking in the cured underfill, which increases the glass transition temperature (T_{g}) of the underfill. A polyglycidyl ether of cresol novolac may be included as part of the epoxy resin component in order to improve high temperature performance. A bis-A epoxy resin may be included to increase the glass transition temperature and/or raise the viscosity of the underfill solution. Whereas a diglycidyl ether of bisphenol F (may herein be referred to as a “bis-F epoxy resin”) may be included to decrease the viscosity. Specific examples of suitable epoxy resins for inclusion in the compositions disclosed herein include, but are not limited to, Bis-F epoxy resins (Epalloy 8229, 8230, 8230E, 8240 and 8240E (CVC Specialty Chemicals Inc. Moorestown, N.J.)), Epiclon® 830, 830-S, 830-LVP, 835 and 835-LV (Dainipppon Ink & Chemicals, Inc. Tokyo, Japan), Epon Resin 862 (Resolution Performance Products, Houston, Tex. USA), RE-304S (Nippon Kayaku Co. Ltd., Tokyo Japan), Bis-A epoxy resins (Epalloy 7190 (CVC Specialty Chemicals Inc. Moorestown, N.J.)), Epon 824 and 828 (Resolution Performance Products, Houston, Tex. USA), Epiclon 840, 840-S, 850, 850-S 850-CRP and 850-LC (Dainipppon Ink & Chemicals, Inc. Tokyo, Japan), DER 330 and 331 (Dow Chemical, Midland, Mich. USA), RE-310S (Nippon Kayaku Co. Ltd., Tokyo Japan), naphthalene epoxy resins (HP-4032 and HP-4032D (Dainipppon Ink & Chemicals, Inc. Tokyo, Japan)), tri-functional epoxy resins (Epikote 1032 (Japan Epoxy Resins Co. Ltd., Tokyo, Japan)), and Tactix 742 or MY510 (triglycidyl ether of paraminophenol), (Huntsman Advanced Materials, Salt Lake City, Utah). In one embodiment, the epoxy resin component comprises 90% of bisphenol F epoxy and 10% of naphthalene epoxy, for example, between about 50% of bisphenol F epoxy and about 50% of bisphenol A epoxy, e.g., between about 80% bisphenol F epoxy and about 20% of MY510. In another embodiment the epoxy resin component comprises 80% of bisphenol F epoxy, 10% of a tri-functional epoxy resin, and 10% of MY510. Any of these illustrative resins may be used in combination with one or more of the illustrative resins or other suitable resins that will be readily selected by the person of ordinary skill in the art, given the benefit of this disclosure.

In certain examples, the stoichiometry of the composition:resin, e.g., hardener:resin, may vary from about 1:1 to about 0.5:1 or about 1:0.5 or any ratio falling within these ratios. It may be advantageous to use a 1:1 composition:epoxy resin ratio to provide an underfill composition having desired properties, e.g., a single glass transition temperature. The exact ratio of the composition:epoxy resin depends, at least in part, on the properties of the selected epoxy and/or composition. It will be within the ability of the person of ordinary skill in the art, given the benefit of this disclosure, to select suitable stoichiometric ratios of composition:epoxy resin to provide underfill compositions suitable for use in the processing of electronic components.

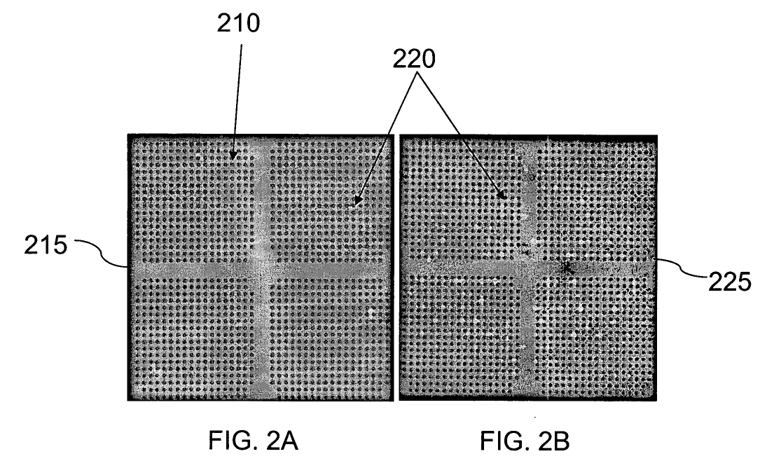

In accordance with certain examples, an underfill composition for use with a lead free solder is provided. In certain examples, the underfill composition comprises an effective amount of a phenol to suppress void formation, e.g., provide less than about 1% voids under a flip chip device, based on the total area occupied by the underfill. Referring to FIGS. 2A-2B, scanning acoustic microscope images of a flip chip device having variable percentages of voids under the flip chip devices are shown. Each of the flip chip devices includes solder bumps 210. Referring to FIG. 2A, a scanning acoustic microscope image of a flip chip device 215 having less than 1% voids, such as void 220, is shown. In FIG. 2B, a scanning acoustic microscope image of a flip chip device 225 having greater than about 5% voids is shown. Without wishing to be bound by any particular scientific theory or this example, greater than about 1% void volume is unacceptable because of the poor performance that will result for the electronic component. Certain examples of the compositions disclosed herein may provide for less than about 1% voids, e.g., less than about 0.5%, about 0.1% or about 0.05% voids, when used in underfill compositions. In certain examples, the compositions disclosed herein may be used in an underfill composition with an electronic component such as, for example, a flip chip to provide substantially no voids under the flip chip. When an underfill composition comprises an epoxy resin and an effective amount of a phenol, the balance of the underfill composition may include one or more of an aromatic amine and a guanidine compound, as discussed elsewhere herein.

In accordance with certain examples, a device comprising a composition that includes an effective amount of a phenol to suppress void formation is disclosed. In some examples, the effective amount of a phenol provides less than about 1% voids under the electronic component. In certain examples, the device may be configured as an electronic component, e.g., a flip chip which includes the composition, or may be configured as a printed circuit board which includes the composition and optionally one or more electronic components. Examples of printed circuit boards include a dielectric substrate having an electrically conductive layer, e.g., a wiring layer, on one or more surfaces. In some examples, the electrically conductive layer may be formed to have a predetermined pattern. In examples using multiple electrically conductive layers, the layers may be connected electrically with each other. The exact nature of the dielectric substrate may vary, and exemplary materials for dielectric substrates include but are not limited to glass, woven and non-woven fabrics, and other suitable materials that are suitable for use with the compositions disclosed herein. In some examples, the dielectric substrate comprises a single layer of material, whereas in other examples the dielectric substrate is a multi-layered structure formed, for example, from a plurality of stacked prepregs. Non-metal or metal foils may also be disposed on one or both surfaces of the dielectric substrate. In certain examples, a metal foil may be disposed on one or more surfaces and etched away to provide a predetermined wiring pattern on the dielectric substrate. In other examples, the electrically conductive layers are not in electrical communication with each other.

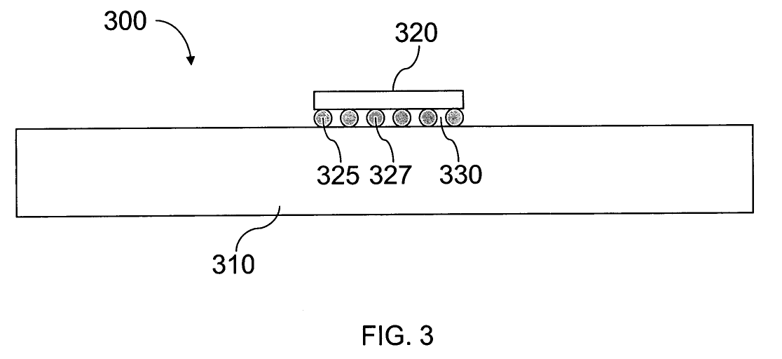

In accordance with certain examples, one or more of the compositions disclosed herein may be used in an underfill composition that may be disposed, injected or otherwise added to space under an electronic component placed on a dielectric substrate, and the resulting assembly may be processed to provide a printed circuit board with the electronic component. Referring to FIG. 3, a printed circuit board 300 generally includes a dielectric substrate 310. Solder bumps or balls, such as solder balls 325 and 327 may be disposed on the dielectric substrate 310. The solder balls may be made from lead based solder or lead free solder. An electronic component 320 may be placed on the solder balls, which can provide electrical communication between the electronic component 320 and the printed circuit board 300. Depending on the solder ball density, spaces, such as space 330, may exist under the electronic component. Such space may be filled in with an underfill composition, e.g., an underfill composition comprising an effective amount of a phenol to suppress void formation. In certain examples, an underfill composition may be injected underneath electronic component 320 prior to processing of the dielectric substrate/electronic component assembly. In some examples, after processing there may be less than about 1% voids underneath electronic component 320, as determined, for example, using scanning acoustic microscopy. In certain examples, there may be substantially no voids under the electronic component after curing. The exact nature of the electronic component may vary and illustrative electronic components include, but are not limited to, a flip chip, a memory chip and the like.

In accordance with certain examples, a method of facilitating assembly of a device is disclosed. The method includes providing a device comprising one or more of the compositions disclosed herein. In certain examples, the method may further include providing instructions for disposal of the composition under an electronic component disposed on the device, e.g., disposed on a printed circuit board. It will be within the ability of the person of ordinary skill in the art, given the benefit of this disclosure, to provide suitable compositions for facilitating assembly of devices such as printed circuit boards.

Certain specific examples of compositions and their use in assembly of a printed circuit board are discussed in more detail below.

### EXAMPLE 1

A composition was prepared using the following reagents (the percentages refer to the percentage by weight): 6% Kayahard PT-AA® 100 (4,4′-methylenedianiline, available from Nippon-Kayaku, eq. wt. 63.5 g/mol); 2.05% Aradur® 2844 (o-toluyl biguanide, available from Huntsman Chemical, eq. wt. ˜14 g/mol); 0.63% MEH 8000 4L (liquid allyl-substituted phenolic novolac available from Meiwa Chemical, eq. wt=141 g/mol); 16.1% Epiclon 830 LVP (diglycidyl ether of Bisphenol F, available from DIC, eq. wt=162 g/mol); 12.1% Araldite MY 0510 (triglycidyl ether of paraminophenol), available from Huntsman Chemical, eq. wt=101 g/mol); 0.38% Silquest A-187 (3-glycidoxypropyltrimethoxysilane, available from OSI Corp); 0.08% Curezol® 2E4MZ (imidazole cure accelerator, available from Air Products); 0.15% BYK-9010 (wetting agent, available from BYK-Chemie); 2.00% Modaflow® 2100 (flow aid, available from Solutia); 0.27% R972 (Fumed silica, available from Degussa); 0.24% Oil black (pigment, avail from Fitz Chemical); and 60% FBISDX (spherical silica, available from Denka).

The following procedure was used to prepare the composition. The Aradur® 2844 was finely mixed with the fumed silica, to produce a fine, free-flowing powder. The remaining ingredients (with the exception of the silica filler) were added, and blended using a high-shear centrifugal mixer (FlackTek® Speedmixer by Hauschild). The silica filler was added portion-wise with hand mixing to produce a thick paste, which was then sent through a roll mill (Exakt® Technologies, Inc), to complete the dispersion. The mixture was degassed under vacuum for 1 hour, packaged in syringes, and stored at −40° C. until used.

The composition was tested using various tests. The peak cure temperature and glass transition temperature were measured according to ASTM D3418-03 (dated 2003). Viscosity measurements were performed at 25° C. using a Brookfield viscometer according to ASTM D2196-99 (dated 1999). The results obtained are shown in Table 1.

TABLE 1

| Test | Results |
|---|---|
| Peak Cure Temperature (° C.) | 170 |
| Glass Transition Temperature (° C.) | 120 |
| Viscosity (cPs) | 50,000 |

### EXAMPLE 2

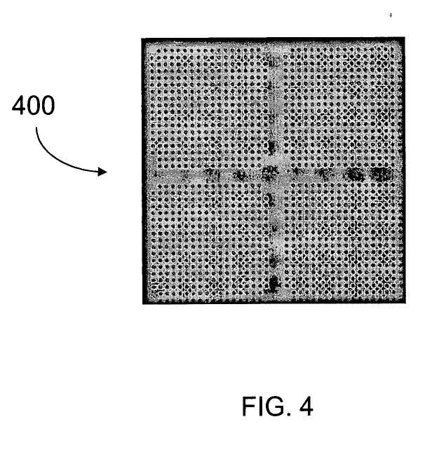

The composition of Example 1 was tested on a Sn/Ag/Cu-bumped FA10 flip chip, obtained from Delphi Electronics (Alpharetta, Ga.). Flip chips were attached to a printed FR4 wiring board having a Tayo AUS5 solder mask using Alpha® 376 EHLV flux, to a dip height of 25 micrometers. After flip chip placement, the board was passed through a Electrovert® Bravo 5-zone reflow oven, with a peak temperature of 240° C., and a time above liquidus of about 50 seconds under a nitrogen atmosphere. After cooling, the flip chips were underfilled using the composition of Example 1 and a Camalot® 1818 liquid dispenser, with a substrate temperature of 100° C. The resulting assembly was oven cured for 90 minutes at 155° C. After cure, the assembly was examined using a Sonix® scanning acoustic microscope for the presence of voids or flow-related defects. No voids were observed under the flip chips, such as flip chip 400 (see FIG. 4). The assembly was then subjected to a JEDEC L3 humidity preconditioning test (see IPC/JEDEC J-STD-020C dated July 2004) followed by three passes in a reflow oven, having a peak temperature of 260° C. The flip chips were then reexamined for voiding, delaminations or solder extrusions. No voiding, delamination or solder extrusions were observed.

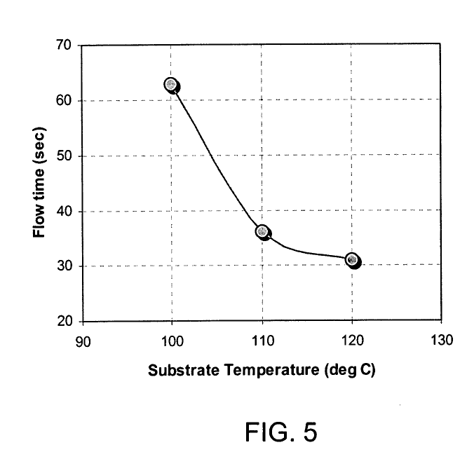

Time to flow measurements of the composition were also performed as a function of temperature using the flip chip device prepared above. The circuit boards were heated to the temperature of interest on a heated platen. The underfill was dispensed on one edge of the flip chip die, and the time required for the material to flow under the die completely and emerge on the other side was recorded with a stopwatch. The flow time was observed to decrease as temperature increased (see FIG. 5 and Table 2 below) due to heat “thinning” (viscosity reduction) of the composition.

TABLE 2

| Substrate Temperature (° C.) | Flow Time (seconds) |
|---|---|
| 100 | 63 |
| 110 | 36 |
| 120 | 31 |

The observed flow time results were suitable for use of the composition in the normal temperature range (90-110° C.) used for dispensing underfill compositions.

When introducing elements of the examples disclosed herein, the articles “a,” “an,” “the” and “said” are intended to mean that there are one or more of the elements. The terms “comprising,” “including” and “having” are intended to be open ended and mean that there may be additional elements other than the listed elements. It will be recognized by the person of ordinary skill in the art, given the benefit of this disclosure, that various components of the examples can be interchanged or substituted with various components in other examples. Should the meaning of the terms of any of the patents, patent applications or publications incorporated herein by reference conflict with the meaning of the terms used in this disclosure, the meaning of the terms in this disclosure are intended to be controlling.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A composition for use with a lead free solder, the composition comprising an effective amount of a phenol to suppress void formation.

2. The composition of claim 1 in which the effective amount of a phenol is about 2 equivalent percent to about 7 equivalent percent of the phenol.

3. The composition of claim 2 further comprising about 93 equivalent percent to about 98 equivalent percent of at least one of an aromatic amine and a guanidine compound.

4. The composition of claim 3 in which the aromatic amine is a compound having formula (I)
R₁—NH₂ (I)
wherein R₁ is selected from one or more members of the group consisting of a substituted phenyl, an unsubstituted phenyl, a substituted naphthyl, an unsubstituted naphthyl, a substituted toluenyl group and an unsubstituted toluenyl group.

5. The composition of claim 4 in which R₁ is selected to provide a compound having formula (II) or formula (III) 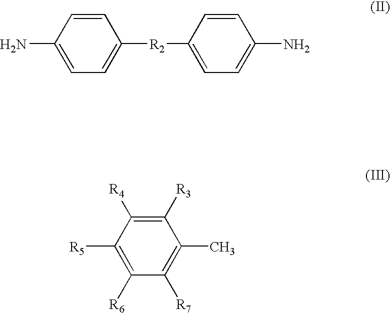
wherein R₂ is a saturated aliphatic hydrocarbon including one to six carbon atoms or is an unsaturated aliphatic hydrocarbon including two to six carbon atoms or wherein at least one of R₃, R₄, R₅, R₆, and R₇ is the —NH₂ group shown in formula (I) and the other remaining groups are independently selected from the group consisting of a saturated aliphatic hydrocarbon including one to about six carbon atoms, a saturated cyclic hydrocarbon including three to about six carbon atoms, an unsaturated aliphatic hydrocarbon including two to about six carbon atoms, and an unsaturated cyclic hydrocarbon including four to about six carbon atoms.

6. The composition of claim 3 in which the phenol comprises a compound having formula (VI) 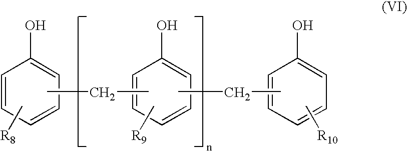
wherein each of R₈, R₉ and R₁₀ is independently selected from the group consisting of hydrogen, a saturated aliphatic hydrocarbon including one to about six carbon atoms, a cyclic saturated hydrocarbon including three to about six carbon atoms, an unsaturated aliphatic hydrocarbon including two to about six carbon atoms, an unsaturated cyclic hydrocarbon including four to about six carbon atoms and aryl, and wherein n is about 1 to about 3.

7. The composition of claim 3 in which the guanidine compound has formula (IX) 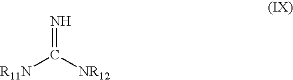
wherein each of R₁₁ and R₁₂ is independently selected from the group consisting of hydrogen, a cyano group, a saturated aliphatic hydrocarbon including one to about six carbon atoms, a cyclic saturated hydrocarbon including three to about six carbon atoms, an unsaturated aliphatic hydrocarbon including two to about six carbon atoms, and an unsaturated cyclic hydrocarbon including four to about six carbon atoms.

8. The composition of claim 7 in which each of R₁₁ and R₁₂ is selected to provide a compound having formula (X) or formula (XI)

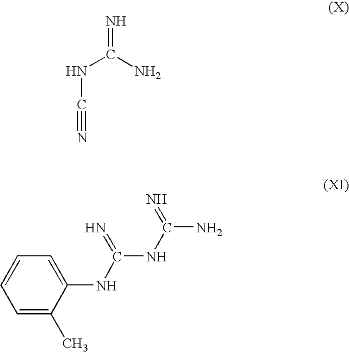

9. The composition of claim 1 further comprising at least one of a stress modifier, a filler, a silane coupling agent, or a wetting agent.

10. The composition of claim 1 further comprising
about 30 equivalent percent to about 90 equivalent percent of an aromatic amine;
about 2 equivalent percent to about 20 equivalent percent of a phenol; and
about 8 equivalent percent to about 65 equivalent percent of a guanidine compound.

11. A composition for use with a lead free solder and in the processing of an electronic component, the composition comprising an effective amount of a phenol to provide less than about 1% voids under the electronic component.

12. The composition of claim 11 further comprising at least one of an aromatic amine and a guanidine compound.

13. The composition of claim 12 in which the effective amount of phenol is effective to provide substantially no voids are under the electronic component.

14. An underfill composition comprising an epoxy resin and the composition of claim 1 in a 1:1 stoichiometry.

15. The underfill composition of claim 14 in which the epoxy resin is one or more members selected from the group consisting of a bisphenol A, a bisphenol F, a bisphenol AD, a bisphenol D, a hydrogenated bisphenol A, a glycidyl ester type epoxy, a glycidylamine type epoxy, a linear aliphatic epoxy, an alicyclic epoxy, a diglycidyl ether of bisphenol A, a diglycidyl ether of bisphenol F, a triglycidyl ether of triphenomethane, a polyglycidyl ether of novolac, a polyglycidyl ether cresol novolac, and a polyglycidyl ether of napthalenic phenol resin.

16. An underfill composition comprising an epoxy resin and the composition of claim 11 in a 1:1 stoichiometry.

17. The underfill composition of claim 16 in which the epoxy resin is one or more members selected from the group consisting of a bisphenol A, a bisphenol F, a bisphenol AD, a bisphenol D, a hydrogenated bisphenol A, a glycidyl ester type epoxy, a glycidylamine type epoxy, a linear aliphatic epoxy, an alicyclic epoxy, a diglycidyl ether of bisphenol A, a diglycidyl ether of bisphenol F, a triglycidyl ether of triphenomethane, a polyglycidyl ether of novolac, a polyglycidyl ether cresol novolac, and a polyglycidyl ether of napthalenic phenol resin.
